(19) United States
(12) Patent Application Publication
(10) Pub. No.: US 2011/0266029 A1
(43) Pub. Date: Nov. 3, 2011

(54) ALUMINUM ALLOY WIRE MATERIAL

(76) Inventors: Shigeki Sekiya, Tokyo (JP); Kuniteru Mihara, Tokyo (JP); Kyota Susai, Tokyo (JP)

(21) Appl. No.: 13/184,727

(22) Filed: Jul. 18, 2011

Related U.S. Application Data
(63) Continuation of application No. PCT/JP2010/050576, filed on Jan. 19, 2010.

(30) Foreign Application Priority Data
Jan. 19, 2009 (JP) 2009-009368

(51) Int. Cl. H01B 5/00; C22C 21/12; C22C 21/02; C22C 21/06; C22C 21/04; C22C 21/16; C22C 21/14

(52) U.S. Cl. 174/126.1; 420/535; 420/538; 420/533; 420/537; 420/543; 420/544; 420/548

(57) ABSTRACT

An aluminum alloy wire material, which has an alloy composition containing: 0.1 to 0.4 mass % of Fe, 0.1 to 0.3 mass % of Cu, 0.02 to 0.2 mass % of Mg, and 0.02 to 0.2 mass % of Si, and further containing 0.001 to 0.01 mass % of Ti and V in total, with the balance being Al and unavoidable impurities, in which a grain size is 5 to 25 μm in a vertical cross-section in a wire-drawing direction thereof, and an average creep rate between 1 and 100 hours is 1×10⁻³ (%/hour) or less by a creep test under a 20% load of a 0.2% yield strength at 150° C.

### TECHNICAL FIELD

The present invention relates to an aluminum alloy wire material that is used as a conductor of an electrical wiring.

### BACKGROUND ART

Hitherto, a member in which a terminal (connector) made of copper or a copper alloy (for example, brass) is attached to electrical wires composed of conductors of copper or a copper alloy, which is called a wire harness, has been used as an electrical wiring for movable bodies, such as automobiles, trains, and aircrafts. In weight reduction of movable bodies in recent years, studies have been progressing on use of aluminum or an aluminum alloy that is lighter than copper or a copper alloy, as a conductor for an electrical wiring.

The specific gravity of aluminum is about one-third of that of copper, and the electrical conductivity of aluminum is about two-thirds of that of copper (when pure copper is considered as a criterion of 100% IACS, pure aluminum has about 66% IACS). Therefore, in order to pass a current through a conductor wire material of pure aluminum, in which the intensity of the current is identical to that through a conductor wire material of pure copper, it is necessary to adjust the cross-sectional area of the conductor wire material of pure aluminum to about 1.5 times larger than that of the conductor wire material of pure copper, but aluminum conductor is still more advantageous than copper conductor in that the former has an about half weight of the latter.

Herein, the term “% IACS” mentioned above represents an electrical conductivity when the resistivity 1.7241×10⁻⁸ Ωm of International Annealed Copper Standard is defined as 100% IACS.

There are some problems in using the aluminum as a conductor of an electrical wiring for movable bodies, one of which is improvement of creep resistance. It is a well-known fact that aluminum has a melting point that is lower by about 500° C. than that of copper, and has a lower heat-resistance than that of copper. A heat circumstance of a movable body is, when an automobile is exemplified as the movable body, about 80° C. at a cabin region in which humans and baggage are boarded under hotness of blazing in the midsummer, and about 150° C. locally in regions of engine rooms and motors for driving in view of their heat generation. They are environmental temperatures at which aluminum is apt to creep.

Furthermore, installation of a cooling means is not envisaged in many cases of environments for providing an electrical wiring on a movable body, unlike environments for providing an overhead electric power transmission line, an electrical power cable, and the like. This is one of the reasons why improvement of the performance of electrical wirings themselves for movable bodies is strongly demanded.

An aluminum electrical wire that is a conductor of an electrical wiring for a movable body is crimped on a terminal. This “crimped” portion is connected to the terminal, to transmit a current or a signal. Therefore, there is fear that the wire is thinned and drawn off from the crimped portion when creep is occurred on the electrical wire on that portion. Examples of the method for crimping, of course, include crimping and insulation piercing connection, but it can be readily expected in either case that the connection strength of the electrical wire is decreased when the wire diameter of the electrical wire is decreased.

Specifically in the case where an electrical wiring is used in a movable body, a sudden stress as well as a small stress due to microvibration are constantly applied to it. Thus, it is considered that the possibility that the electrical wire is taken off from the terminal is higher than those in general electronic equipments (for example, internal wirings of personal computers, television sets, and the like).

Therefore, also in view of reliability of connection, it is necessary to develop an aluminum conductor excellent in creep resistance, for use in movable bodies.

With respect to such a use, pure aluminum (1000-series) is often used in electric power transmission lines. As shown in Non-Patent Literatures 1 and 2, it is considered that a pure aluminum material has poorer creep resistance than that of an alloy material. Accordingly, alloying by adding various additive elements has been studied. However, it is also a well-known fact that alloying causes decrease in electrical conductivity. Therefore, in view of electrical conductivity, 2000-series and 6000-series that are excellent in creep resistance cannot be used, and other alloy-systems are also not so good.

Herein, creep is explained. Creep means to a phenomenon in which plastic deformation proceeds with the lapse of time, under a constant stress, or load. At a high temperature region at which diffusion of atoms is not negligible, plastic deformation occurs even under a load equal to or less than a yield stress which does not depend on a temperature or a strain rate, and a strain increases with the lapse of time, even under a constant stress, to lead to breakage. In the case of aluminum, creep at this high temperature region is occurred on or above about 150° C.

It is necessary that the above-mentioned aluminum conductor is connected to a copper terminal permanently and securely, and as a guide for determining the reliability thereof, it is desired that the heat-resistance thereof satisfies a specific value required. However, it is not considered that pure aluminum-based materials which are used as electric power transmission lines and electrical power cables, and the alloys described in Patent Literatures 1 to 13 which mainly relate to wire harnesses for automobiles, have properties and costs that are sufficient for use in movable bodies.

Specifically, in the alloys described, for example, in Patent Literatures 1, 3, 4, 8, and 11 to 13, the creep resistance is improved by providing an alloy to which Zr is added, but the electrical conductivity is conspicuously decreased. Furthermore, there is another problem that a heat treatment for a long time period is required for forming an Al₃Zr intermetallic compound, which makes control of the process difficult.

Furthermore, as mentioned above, an aluminum (alloy) conductor causes creep more easily when the conductor is applied a compression stress, by being connected (insulation piercing connected, crimped, or the like) to a copper terminal. The amount of compression is about 5 to 50%, although it varies depending on the kind of the terminal and the wire diameter of the conductor. Therefore, it is desired that the aluminum (alloy) conductor has a property that creep hardly occurs in the state of undergoing compression working.

In view of the above, an aluminum (alloy) conductor has been required, not only which is simply evaluated on deterioration of the mechanical strength of an annealed material before and after a heat treatment, but also which is evaluated on creep resistance in a state of being applied a working strain thereto, which mimics a crimped portion between a copper terminal and the conductor, for the evaluation of the creep resistance that embodies the reliability of the aluminum conductor which is used in electrical or electronic equipments for use in movable bodies, such as automobiles and trains.

### CITATION LIST

### Patent Literature

Patent Literature 1: JP-A-2004-311102 (“JP-A” means unexamined published Japanese patent application)
Patent Literature 2: JP-A-2006-12468
Patent Literature 3: Japanese Patent No. 3530181
Patent Literature 4: JP-A-2005-336549
Patent Literature 5: JP-A-2004-134212
Patent Literature 6: JP-A-2005-174554
Patent Literature 7: JP-A-2006-19164
Patent Literature 8: JP-A-2006-79885
Patent Literature 9: JP-A-2006-19165
Patent Literature 10: JP-A-2006-19163
Patent Literature 11: JP-A-2006-253109
Patent Literature 12: JP-A-2006-79886
Patent Literature 13: JP-A-2000-357420

### Non-Patent Literature

Non-Patent Literature 1: Light Metal, Vol. 19, No. 7, pp. 310-315 (1969), “High Temperature Creep Property of Aluminum Dilute Binary Alloy”
Non-Patent Literature 2: Light Metal, Vol. 34, No. 1, pp. 8-13 (1984), “Effect of Load Retention Time on Hardness of Aluminum Alloy and Room Temperature Creep Test”

### SUMMARY OF INVENTION

### Technical Problem

The present invention is contemplated for providing an aluminum alloy wire material that is excellent in creep resistance in which creep is hard to be occurred even in a state in which the wire material is underwent compression working, and that is also excellent in tensile strength and electrical conductivity, without requiring addition of Zr, and that is used as a conductor of an electrical wiring of a movable body.

### Solution to Problem

In view of such the circumstances, the inventors of the present invention have found a method for suitably evaluating desirable creep resistance of an aluminum alloy wire material that is used as a conductor of an electrical wiring of a movable body. Furthermore, we have found that creep resistance as well as tensile strength and electrical conductivity can be improved, by properly defining the alloying elements contained in the aluminum alloy and the grain size of a vertical cross-section in the wire drawing direction, so as to satisfy the creep resistance that is required in the evaluation method. The present invention is attained based on those findings.

That is, the present invention is to provide:

(1) An aluminum alloy wire material, which has an alloy composition comprising: 0.1 to 0.4 mass % of Fe, 0.1 to 0.3 mass % of Cu, 0.02 to 0.2 mass % of Mg, and 0.02 to 0.2 mass % of Si, and further comprising 0.001 to 0.01 mass % of Ti and V in total, with the balance being Al and unavoidable impurities, wherein a grain size is 5 to 25 μm in a vertical cross-section in a wire-drawing direction thereof, and an average creep rate between 1 and 100 hours is 1×10⁻³ (%/hour) or less by a creep test under a 20% load of a 0.2% yield strength at temperature 150° C.;

(2) An aluminum alloy wire material, which has an alloy composition comprising: 0.1 to 0.4 mass % of Fe, 0.1 to 0.3 mass % of Cu, 0.02 to 0.2 mass % of Mg, and 0.02 to 0.2 mass % of Si, and further comprising 0.001 to 0.01 mass % of Ti and V in total, with the balance being Al and unavoidable impurities, which is subjected to final annealing, followed by cold working at reduction ratio 5 to 50%, wherein a grain size is 5 to 25 μm in a vertical cross-section in a wire-drawing direction of the wire material, and an average creep rate between 1 and 100 hours is 5×10⁻³ (%/hour) or less by a creep test under a 20% load of a 0.2% yield strength at temperature 150° C.;

(3) An aluminum alloy wire material, which has an alloy composition comprising: 0.3 to 0.8 mass % of Fe, and 0.02 to 0.5 mass % of at least one element selected from the group consisting of Cu, Mg, and Si in total, and further comprising 0.001 to 0.01 mass % of Ti and V in total, with the balance being Al and unavoidable impurities, wherein a grain size is 5 to 30 μm in a vertical cross-section in a wire-drawing direction thereof, and an average creep rate between 1 and 100 hours is 1×10⁻³ (%/hour) or less by a creep test under a 20% load of a 0.2% yield strength at temperature 150° C.;

(4) An aluminum alloy wire material, which has an alloy composition comprising: 0.3 to 0.8 mass % of Fe, and 0.02 to 0.5 mass % of at least one element selected from the group consisting of Cu, Mg, and Si in total, and further comprising 0.001 to 0.01 mass % of Ti and V in total, with the balance being Al and unavoidable impurities, which is subjected to final annealing, followed by cold working at reduction ratio 5 to 50%, wherein a grain size is 5 to 30 μm in a vertical cross-section in a wire-drawing direction of the wire material, and an average creep rate between 1 and 100 hours is 5×10⁻³ (%/hour) or less by a creep test under a 20% load of a 0.2% yield strength at temperature 150° C.;

(5) The aluminum alloy wire material according to any one of (1) to (4), wherein a tensile strength is 80 MPa or more, and an electrical conductivity is 55% IACS or more; and

(6) The aluminum alloy wire material according to any one of (1) to (5), which is mounted on a movable body as a wiring, and used as an electric conductor for a battery cable, a harness, or a motor.

Herein, in the present invention, the term “reduction ratio” is a numerical value (%) represented by the formula: {(cross-sectional area before working−cross-sectional area after working)/cross-sectional area before working}×100.

### Advantageous Effects of Invention

The aluminum alloy wire material of the present invention is a conductor which is excellent in creep resistance and is also excellent in tensile strength and electrical conductivity, which is useful as a conductor to be mounted on a movable body, specifically as a conductor for battery cables, harnesses, and motors.

### BRIEF DESCRIPTION OF THE DRAWINGS

FIG. 1 is a graph showing a creep curve, which is a typical relative relationship between a strain and a time period, and which is obtained by conducting a usual creep test.

FIG. 2 is a graph showing a state in which tangent lines are drawn with respect to each stage on the creep curve obtained in FIG. 1.

### MODE FOR CARRYING OUT THE INVENTION

A preferable first embodiment of the present invention is an aluminum alloy wire material, which has an alloy composition comprising: 0.1 to 0.4 mass % of Fe, 0.1 to 0.3 mass % of Cu, 0.02 to 0.2 mass % of Mg, and 0.02 to 0.2 mass % of Si, and further comprising 0.001 to 0.01 mass % of Ti and V in total, with the balance being Al and unavoidable impurities, wherein a grain size is 5 to 25 μm in a vertical cross-section in the wire-drawing direction thereof, and an average creep rate between 1 and 100 hours is 1×10⁻³ (%/hour) or less by a creep test under a 20% load of a 0.2% yield strength at temperature 150° C. The aluminum alloy wire material of this embodiment is excellent in creep resistance.

In this embodiment, the reason why the content of Fe is set to 0.1 to 0.4 mass % is to utilize various effects by mainly Al—Fe-based intermetallic compounds. Fe is made into a solid solution in aluminum in an amount of only about 0.05 mass % at a temperature (655° C.) around the melting point, and is made into a solid solution lesser at room temperature. The remainder of Fe is crystallized or precipitated as intermetallic compounds, such as Al—Fe, Al—Fe—Si, Al—Fe—Si—Mg, and Al—Fe—Cu—Si. The crystallized or precipitated product acts as a refiner for grains to make the grain size fine, and enhances the mechanical strength. When the content of Fe is too small, this effect becomes insufficient. When the content is too large, the effect is saturated, which is not desirable from industrial viewpoints. The content of Fe is preferably 0.15 to 0.3 mass %, more preferably 0.18 to 0.25 mass %.

In this embodiment, the reason why the content of Cu is set to 0.1 to 0.3 mass % is to make Cu into a solid solution in an aluminum matrix, to strengthen the resultant alloy, and to improve creep resistance. In such a case, when the content of Cu is too small, the effect thereof cannot be sufficiently exerted, and when the content is too large, decrease in electrical conductivity is caused. Furthermore, when the content of Cu is too large, Cu forms intermetallic compounds with other elements, to cause a defect, such as occurrence of slag upon melting, and the like. The content of Cu is preferably 0.15 to 0.25 mass %, more preferably 0.18 to 0.22 mass %.

In this embodiment, the reason why the content of Mg is set to 0.02 to 0.2 mass % is to make Mg into a solid solution in an aluminum matrix, to strengthen the resultant alloy, and to improve creep resistance. Further, another reason is to make a part of Mg form a precipitate with Si, to enhance mechanical strength. When the content of Mg is too small, the above-mentioned effects are insufficient, and when the content is too large, electrical conductivity is decreased and the effects are also saturated. Furthermore, when the content of Mg is too large, Mg forms intermetallic compound with other elements, to cause a defect, such as occurrence of slag upon melting, and the like. The content of Mg is preferably 0.05 to 0.15 mass %, more preferably 0.08 to 0.12 mass %.

In this embodiment, the reason why the content of Si is set to 0.02 to 0.2 mass % is to make Si form a compound with Mg, to enhance the mechanical strength, as mentioned above. When the content of Si is too small, the above-mentioned effect becomes insufficient, and when the content is too large, the electrical conductivity is decreased and the effect is also saturated. Furthermore, when the content of Si is too large, Si forms intermetallic compounds with other elements, to cause a defect, such as occurrence of slag upon melting, and the like. The content of Si is preferably 0.05 to 0.15 mass %, more preferably 0.08 to 0.12 mass %.

In this embodiment, Ti and V each act as a refiner for microstructure of an ingot in melt-casting. If the microstructure of the ingot is coarse, cracks occur in the next working step, which is not desirable from industrial viewpoints. Thus, Ti and V are added so as to refine the microstructure of the ingot. When the content of Ti and V in total is too small, the effect of refining is insufficient, and when the total content is too large, electrical conductivity is conspicuously decreased and the effects are also saturated. The content of Ti and V in total is preferably 0.05 to 0.08 mass %, more preferably 0.06 to 0.08 mass %. Furthermore, when Ti and V are used together, the ratio Ti:V (by mass ratio) is preferably 10:1 to 10:3.

A preferable second embodiment of the present invention is an aluminum alloy wire material, which has an alloy composition comprising: 0.3 to 0.8 mass % of Fe, and 0.02 to 0.5 mass % of at least one element selected from the group consisting of Cu, Mg, and Si in total, and further comprising 0.001 to 0.01 mass % of Ti and V in total, with the balance being Al and unavoidable impurities, wherein a grain size is 5 to 30 μm in a vertical cross-section in the wire-drawing direction thereof, and an average creep rate between 1 and 100 hours is 1×10⁻³ (%/hour) or less by a creep test under a 20% load of a 0.2% yield strength at temperature 150° C. Similarly to the first embodiment, the aluminum alloy wire material of this embodiment is also excellent in creep resistance.

In the second embodiment, the reason why the content of Fe is set to 0.3 to 0.8 mass % is that, when the content of Fe is too small, the effects of enhancing mechanical strength and improving creep resistance become insufficient, depending on the contents of other elements (specifically Cu, Mg, Si); whereas, when the content is too large, the precipitated intermetallics are formed excessively, which causes breakage of the wire upon a wire-drawing step. The content of Fe is preferably 0.4 to 0.8 mass %, more preferably 0.5 to 0.7 mass %.

Further, in the second embodiment, the reason why the content of Cu, Mg, and Si in total is set to 0.02 to 0.5 mass % is that, when the total content is too small, effects of enhancing mechanical strength and improving creep resistance are insufficient, and when the total content is too large, electrical conductivity is decreased. Furthermore, when the total content is too large, those elements form intermetallic compounds with other elements selected, to cause a defect, such as occurrence of slag upon melting, and the like. The content of Cu, Mg, and Si in total is preferably 0.1 to 0.4 mass %, more preferably 0.15 to 0.3 mass %.

Other composition of the alloy is the same as that of the above-mentioned first embodiment.

The aluminum alloy wire material of the present invention is produced, under strict control of the grain size and the creep rate, in addition to the above-mentioned alloy composition.

### (Grain Size)

The wire material of the aluminum alloy wire material of the first embodiment has a grain size of 5 to 25 μm, preferably 8 to 15 μm, more preferably 10 to 12 μm, in a vertical cross-section in the wire-drawing direction. This is because, when the grain size is too small, an uncrystallized texture remains partially, and elongation is conspicuously decreased; and when the grain size is too large, a coarse texture is formed, and deformation behavior becomes uneven, whereby elongation is decreased similarly, to cause a defect upon connecting (fitting) with a copper terminal.

Furthermore, the aluminum alloy wire material of the second embodiment, whose Fe content is high, has a grain size of 5 to 30 μm, preferably 8 to 15 μm, more preferably 10 to 12 μm, in a vertical cross-section in the wire-drawing direction of the wire material. When the content of Fe is higher, the grain size tends to be finer, whereby non-recrystallized region may remain. Accordingly, when the amount of Fe is high, it is preferable to conduct a heat treatment at a slightly higher temperature.

### (Creep Resistance)

In the above-mentioned first and second embodiments, the average creep rate between 1 and 100 hours is 1×10⁻³ (%/hour) or less by a creep test under a 20% load of a 0.2% yield strength at temperature 150° C.

Herein, The Aluminum Handbook (6^{th} edition), edited by the Japan Aluminium Association, describes that a creep phenomenon occurs at a considerably lower temperature side around 100° C. Therefore, the temperature condition of the preset temperature, 150° C., is a suitable temperature as a condition for the evaluation of a wire material that is used after deployed it on an actual movable body.

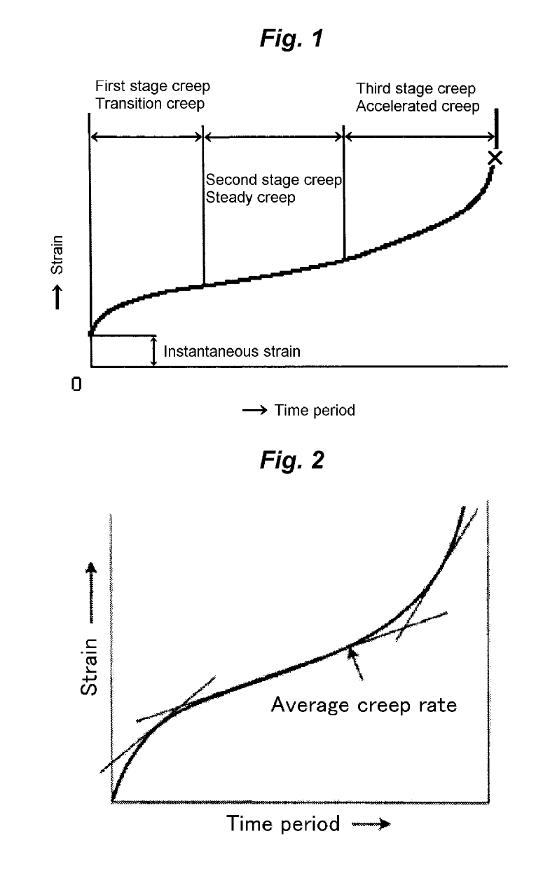

FIG. 1 is a graph showing a typical relative relationship between a strain and a time period, which is obtained by conducting a usual creep test. In FIG. 1, the vertical axis represents a strain, and the strain becomes larger as it goes upwardly; and the horizontal axis represents a time period, and the lapsed time becomes longer as it goes to the righter side. Further, “×” represents a broken point. As shown in FIG. 1, creep is typically classified into three sections: the first stage creep (transition creep), the second stage creep (steady creep), and the third stage creep (accelerated creep). In this case, it is important to retard the steady creep rate of the second stage creep for enhancing creep resistance. Therefore, a small creep rate in the second stage is desired.

In the first and the second embodiments of the present invention, the average creep rate between 1 and 100 hours after starting of a creep test according to JIS Z 2271 is 1×10⁻³ (%/hour) or less, preferably 0.5×10⁻³ (%/hour) or less, more preferably 0.1×10⁻³ (%/hour) or less, in a state in which 20% of a 0.2% yield strength is loaded at temperature 150° C. in the creep test. Although the lower limit of the average creep rate is not particularly limited, it is generally 1×10⁻⁵%/hour or more. The reason why the average creep rate between 1 and 100 hours is defined is that, when the first stage creep (transition creep) was excluded, and data of several alloys up to 1,000 hours was obtained and compared with the data up to 100 hours, no difference in the slope (which is nearly equal to the creep rate) was observed.

Herein, evaluation was conducted with a test piece that is different from one as stipulated in JIS Z 2271. Since the test piece shown in the above-mentioned JIS cannot be prepared from a wire piece (diameter: φ0.3), a reference gauge length was marked, to measure the creep elongation. Other conditions for the measurement were those according to those stipulated in the above-mentioned JIS.

Further, in general, when a loaded stress is high, a creep rate is fast; on the other hand, when a loaded stress is low, a creep rate is slow. In the cases of electrical wires for general use, electrical wires used in movable bodies, which are the present usage, and the like, a stress loaded during use is low. For example, an electrical wire for a wire harness that is used in an automobile of a movable body, is generally provided with an insulation material. Further, it may be also provided, for example, with a tape for bundling several electrical wires, and also with a joint, a connector housing, and the like, which are attached to a portion depending therefrom in rare cases. However, the total weight of those is still small, and thus a high stress is not loaded on the electrical wire. Accordingly, in the present invention, the average creep rate is defined by a value loading 20% of a 0.2% yield strength. Herein, the term “0.2% yield strength” means a value (yield stress) obtained in a tensile test (JIS Z 2241). The term “20% of the 0.2% yield strength is loaded” means, for example, that 10 MPa is applied when the 0.2% yield strength (yield stress) is 50 MPa.

Further, the term “the average creep rate is 1×10⁻³ (%/hour)” means that the creep elongation after 100 hours is 0.1%. At a rate of this value or less, no problem is arisen in the practical use in most cases.

In the case of a movable body that is a subject of the use of the electrical conductor of the present invention, the durable time period for use is 87,600 hours for 10 years, and about 175,000 hours for 20 years.

One of evaluation methods using various temperatures and periods of time as parameters is an evaluation method with a Larson-Miller parameter (LMP) (Mathematical Formula 1). This is a concept in which heat energies underwent in experiments under various temperatures and time periods changed, are evaluated equivalently.

Larson-Miller parameter (LMP)=T×(20+Log(t)) (Mathematical Formula 1)

wherein the unit of T (temperature) is K (absolute temperature), and the unit of t (time) is hour.

The aluminum alloy wire material of the present invention is preferably an aluminum alloy wire material that is used in a movable body, and the maximum temperature at which the wire material is used is the temperature in an engine room of a vehicle, as mentioned above. However, it is expected that the maximum temperature is not maintained over a long time period, and that the wire material is maintained at a temperature equal to or lower than the temperature (for example, 80° C.: about 353 K) for a long time period under an interior circumstance, such as a cabin.

Accordingly, if the wire material is maintained at 80° C. for 10 years, the Larson-Miller parameter (LMP) is about 8,800, and if the wire material is maintained at 80° C. for 20 years, the LMP is about 8,910.

In the above-mentioned evaluation condition (for 100 hours at temperature 150° C.), the Larson-Miller parameter (LMP) is about 9,300, and an energy equivalent to this parameter is 200 years or longer at 80° C. Therefore, an evaluation in which the wire material is maintained at temperature 150° C. for 100 hours is sufficient, since the value of LMP in this evaluation is higher than that in the case where the wire material is maintained at 80° C. for 10 year.

FIG. 2 is a graph showing a state in which tangent lines are drawn with respect to each stage on the creep curve obtained in FIG. 1. Among these tangent lines, the slope of the tangent line at the steady creep in the second stage is defined as the average creep rate. In the present invention, the second stage comprises 1 to 100 hours after initiation of the test.

The aluminum alloy wire material of the present invention preferably has a tensile strength of 80 MPa or more and an electrical conductivity of 55% IACS or more, more preferably has a tensile strength of 80 to 150 MPa and an electrical conductivity of 55 to 65% IACS, further preferably has a tensile strength of 100 to 120 MPa and an electrical conductivity of 58 to 62% IACS.

The tensile strength and the electrical conductivity are conflicting properties, and the higher the tensile strength is, the lower the electrical conductivity is, whereas pure aluminum low in tensile strength is high in electrical conductivity. Therefore, in the case where an aluminum electrical conductor has a tensile strength of 80 MPa or less, such a conductor is so weak that a considerable caution is required for handling, which is difficult for use as an industrial conductor. It is preferable that the electrical conductivity is 55% IACS or more, since a high current of dozens of amperes (A) is to pass through it when the wire material is used as a power line.

The aluminum wire material of the present invention can be produced via steps of: melting, hot- or cold-working (e.g. caliber rolling with grooved rolls), wire drawing, and heat treatment (preferably, specific annealing as in below).

The aluminum alloy wire material of the above-mentioned first embodiment can be produced, for example, in the following manner. An ingot is prepared, by melting and casting 0.1 to 0.4 mass % of Fe, 0.1 to 0.3 mass % of Cu, 0.02 to 0.2 mass % of Mg, and 0.02 to 0.2 mass % of Si, 0.001 to 0.01 mass % of Ti and V in total, with the balance being Al and unavoidable impurities. The ingot is subjected to hot caliber rolling, to give a rod material. The surface of the rod material is then subjected to shaving, followed by wire drawing. The thus-worked material is subjected to intermediate annealing (for example, at 300 to 450° C. for 1 to 4 hours), followed by wire drawing. Then, the thus-worked material is further subjected to a heat treatment as final annealing (annealing that is conducted finally, through the production process of the wire material) via any of batch heat treatment, electric current annealing, or CAL (continuous annealing), followed by, if necessary, final cold working at a predetermined reduction ratio. In this manner, the aluminum alloy wire material can be produced.

Further, the aluminum alloy wire material of the above-mentioned second embodiment can be produced, for example, in the following manner. An ingot is prepared, by melting and casting 0.3 to 0.8 mass % of Fe, 0.02 to 0.5 mass % of at least one element selected from Cu, Mg, and Si in total, 0.001 to 0.01 mass % of Ti and V in total, with the balance being Al and unavoidable impurities. The ingot is subjected to hot caliber rolling, to give a rod material of about 10 mmφ. The surface of the rod material is then subjected to shaving, followed by wire drawing. The thus-worked material is subjected to heat treatment as intermediate annealing (for example, at 300 to 450° C. for 1 to 4 hours), followed by wire drawing. Then, the thus-worked material is further subjected to a heat treatment as final annealing via any of batch heat treatment, electric current annealing, or CAL, followed by, if necessary, final cold working at a predetermined reduction ratio. In this manner, the aluminum alloy wire material can be produced.

The cooling speed when the molten metal is cast to give the ingot, is generally 0.5 to 180° C./sec, preferably 0.5 to 50° C./sec, more preferably 1 to 20° C./sec. By setting the cooling speed to the above-mentioned range, the amount of Fe as a solid solution, and the size and density of a Fe-based precipitated product can be controlled.

The creep rate and the grain size are closely related to each other. In general, a material with large grain size tends to have a low creep rate, whereas a material with small grain size tends to have a high creep rate. This is an example of a solid solution-type alloy. In the present invention, the heat treatment as the final annealing is preferably conducted as follows, so as to control grain size.

First, in the case of batch-type annealing, a desired grain size of 5 to 25 μm or 5 to 30 μm can be obtained, by subjecting the wire-drawn material to a heat treatment at 300 to 450° C. for 10 to 120 minutes, Preferably, the temperature is 350 to 450° C., and the time period is 30 to 60 minutes.

On the other hand, when a continuous annealing is conducted, the following two methods are exemplified. One method is the electric current annealing. In this method, a current that is continuously applied to between electrode sieves is passed through the wire material, whereby the Joule heat generated in the wire material anneals the wire material continuously. It is preferable that the voltage is 20 to 40 V, the value of the current is 180 to 360 A, and the wire feeding rate is preferably 100 to 1,000 m/min.

The other method is the CAL (continuous annealing) system in which annealing is conducted by feeding the drawn wire material in a heated furnace. In this method, recrystallization annealing is conducted, by feeding the drawn wire material in the furnace heated to preferably 400 to 550° C., more preferably 420 to 500° C., and a desired grain size can be obtained by changing the line speed.

The full length of the heat treatment furnace is preferably 100 to 1,000 cm, and the line speed is preferably 30 to 150 m/min.

Another embodiment of the present invention is an aluminum alloy wire material, which is obtained by conducting the final annealing similar to that mentioned above, followed by cold working at reduction ratio 5 to 50%, which wire material has an average creep rate between 1 and 100 hours of 5×10⁻³ (%/hour) or less, preferably 3×10⁻³ (%/hour) or less, more preferably 1×10⁻³ (%/hour) or less, by a creep test under a 20% load of a 0.2% yield strength at temperature 150° C. Although the lower limit value of the average creep rate is not particularly limited, it is generally 1×10⁻⁵%/hour or more. Since the above-mentioned aluminum alloy wire material that has been subjected to the cold working after the final annealing, has a higher hardness due to work hardening than that of an un-worked material, it causes no problem in the practical use in many cases, as long as it has an average creep rate of 5×10⁻³ (%/hour) or less, even it is used, for example, at a connection portion with a terminal, and the like. However, a lower average creep rate is preferable. Furthermore, the alloy composition, grain size, tensile strength, and electrical conductivity in this embodiment are similar to those in the above-mentioned first and second embodiments.

Furthermore, the reason why the reduction ratio in the cold working is set to the above-mentioned range is as follows. Namely, in the case where the wire material is connected to a terminal (connector) made of copper, in view of the compression ratio of a conventional conductor made of copper, when the reduction ratio at the cold working is too low, a sufficient connection strength cannot be obtained; on the other hand, when the reduction ratio is too high, excess high-working is not necessary since the applied strain is saturated. The reduction ratio at the cold working is preferably 10 to 40%, more preferably 20 to 30%.

The aluminum alloy wire material of the present invention can be preferably used as, but not limited to, for example, an electrical conductor for a battery cable, harness, or motor, each of which is used in a movable body.

Further, examples of the movable body in which the aluminum alloy wire material of the present invention is to be mounted, include vehicles (e.g. automobiles), trains, and aircrafts.

### EXAMPLES

The present invention will be described in more detail based on examples given below, but the invention is not meant to be limited by these.

### Examples 1 to 30, and Comparative examples 1 to 21

Fe, Cu, Mg, Si, Ti, V, and Al were melted in a siliconit furnace with a graphite pot in the amounts shown in Tables 1 and 2, followed by casting, to produce a respective inch bar ingot of 25×25 mm×300 mm. At that time, a K-type thermocouple was set at the inside of a cast mold, so that the temperature was continuously monitored every 0 to 2 seconds, and an average cooling speed from solidification to 200° C. was obtained. The respective ingot was subjected to hot caliber rolling, to prepare a rod material with diameter of about 10 mmφ. The surface of the rod material was then subjected to shaving to diameter 9 to 9.5 mmφ, followed by wire-drawing to diameter 2.6 mmφ. The thus-drawn material was subjected to intermediate annealing under the conditions of temperature 300 to 450° C. for 1 to 4 hours, followed by wire-drawing, and any final annealing selected from a batch heat treatment (A), an electric current annealing (B), or a CAL (continuous annealing) heat treatment (C), under the conditions described in the column of ‘Heat treatment’ ‘Method’ in Tables 1 and 2. Finally, cold working was conducted at the reduction ratio (abbreviated to “Red. ratio”), as shown in Tables 1 to 4 as necessary, to produce an aluminum alloy wire material with diameter 0.31 mmφ, respectively. The thermal histories and the wire-drawings (wire diameters) by which the reduction ratios conducted in Examples and Comparative examples can be obtained, are shown below.

Reduction ratio 0%: (Intermediate annealing)→0.31 mmφ→(Final annealing)

Reduction ratio 5%: (Intermediate annealing)→0.32 mmφ→(Final annealing)→0.31 mmφ

Reduction ratio 10%: (Intermediate annealing)→0.33 mmφ→(Final annealing)→0.31 mmφ

Reduction ratio 20%: (Intermediate annealing)→0.35 mmφ→(Final annealing)→0.31 mmφ

Reduction ratio 30%: (Intermediate annealing)→0.37 mmφ→(Final annealing)→0.31 mmφ

Reduction ratio 40%: (Intermediate annealing)→0.40 mmφ→(Final annealing)→0.31 mmφ

Reduction ratio 50%: (Intermediate annealing)→0.44 mmφ→(Final annealing)→0.31 mmφ

The electric current annealing (B) was conducted under the conditions of: the distance between the electrodes of 80 cm, and the wire feeding speed of 300 to 800 m/min. The CAL heat treatment (C) was conducted under the condition of: the full length of the heat treatment furnace of 310 cm.

With respect to the aluminum alloy wire materials prepared in Examples (Ex) and Comparative examples (Comp. ex), the properties were measured according to the methods described below, and the results thereof are shown in Tables 1 to 4.

### (a) Grain Size (GS)

The transverse cross-section of a sample that was cut out in the wire-drawing direction was embedded with a resin, followed by mechanical polishing, and electrolytic polishing. The conditions of the electrolytic polishing were as follows: polish liquid, a 20% ethanol solution of perchloric acid; liquid temperature, 0 to 5° C.; current, 10 mA; voltage, 10 V; and time period, 30 to 60 seconds. The resultant microstructure was observed by an optical microscope with a magnification of 200× to 400× and photographed, and the grain size was measured by an intersection method. Specifically, the photographed picture was enlarged to about 4-fold, straight lines were drawn thereon, and the number of intersections of the straight lines and grain boundaries was measured, to obtain the average grain size. The grain size was evaluated by changing the length and the number of straight lines so that 100 to 200 grains would be counted.

### (b) Tensile Strength (TS)

Three test pieces which were cut out in the wire-drawing direction, were tested according to JIS Z 2241, and the average value was obtained.

### (c) Electrical Conductivity (EC)

A test piece with length 350 mm which was cut out in the wire-drawing direction, was immersed in a thermostat bath maintained at 20° C. (±2° C. and electric resistance was measured by using a four terminal method, to calculate the electrical conductivity. The distance between the terminals was 300 mm.

### (d) Creep Rate

Using a creep test apparatus according to JIS Z 2271, an average creep rate between 1 and 100 hours was obtained, by loading 20% of a 0.2% yield strength at temperature 150° C. In Tables 1 and 2, the unit “(%/hour)” is expressed as “(%/hr)”.

The 0.2% yield strength (YS) was determined, by testing three test pieces that were cut out in the wire-drawing direction according to JIS Z 2241, reading the load corresponding to the YS upon the test from a chart, and dividing the load by the cross-sectional area of the test piece, to obtain the average value.

TABLE 1

| | | | | | | | Cooling | Red. | | | | | |
|---|---|---|---|---|---|---|---|---|---|---|---|---|---|
| Ex | Fe | Cu | Mg | Si | Ti + V | Al | speed | ratio | Heat treatment | GS | TS | EC | Creep rate |
| No. | (mass %) | | | | | | (° C./sec) | (%) | Method | (μm) | (MPa) | (% IACS) | ×10⁻³ (%/hr) |
| 1 | 0.3 | 0.1 | 0.12 | 0.05 | 0.002 | Bal. | 120 | 0 | A: 350° C., 1 h | 12 | 121 | 61.0 | 0.3 |
| 2 | | | | | | | | | B: 27 V, 238 A | 10 | 123 | 60.8 | 0.2 |
| 3 | | | | | | | | | C: 430° C., 40 m/min | 11 | 119 | 60.6 | 0.3 |
| 4 | | | | | | | | 20 | A: 400° C., 0.5 h | 12 | 130 | 60.7 | 0.9 |
| 5 | | | | | | | | 40 | C: 450° C., 100 m/min | 10 | 145 | 60.5 | 1.3 |
| 6 | 0.14 | 0.12 | 0.04 | 0.03 | 0.001 | Bal. | 50 | 0 | A: 300° C., 1.5 h | 8.8 | 123 | 61.8 | 0.2 |
| 7 | | | | | | | | | B: 25 V, 258 A | 15 | 120 | 61.6 | 0.1 |
| 8 | | | | | | | | | C: 460° C., 150 m/min | 13 | 128 | 62.0 | 0.2 |
| 9 | | | | | | | | 20 | A: 370° C., 2 h | 14 | 128 | 62.1 | 0.7 |
| 10 | | | | | | | | 40 | C: 530° C., 60 m/min | 15 | 147 | 62.0 | 1.1 |
| 11 | 0.39 | 0.28 | 0.18 | 0.15 | 0.007 | Bal. | 10 | 0 | A: 390° C., 1 h | 11 | 127 | 60.1 | 0.3 |
| 12 | | | | | | | | | B: 30 V, 288 A | 13 | 121 | 59.8 | 0.4 |
| 13 | | | | | | | | | C: 400° C., 90 m/min | 9.3 | 126 | 59.5 | 0.2 |
| 14 | | | | | | | | 30 | A: 440° C., 0.5 h | 12 | 138 | 59.3 | 0.9 |
| 15 | | | | | | | | 50 | C: 430° C., 120 m/min | 6.5 | 155 | 59.0 | 1.2 |
| 16 | 0.32 | 0.15 | 0.1 | 0.1 | 0.002 | Bal. | 180 | 0 | A: 310° C., 2 h | 10 | 108 | 60.9 | 0.3 |
| 17 | | | | | | | | | A: 370° C., 2 h | 13 | 109 | 60.3 | 0.4 |
| 18 | | | | | | | | | A: 440° C., 2 h | 15 | 107 | 60.5 | 0.3 |
| 19 | 0.28 | 0.13 | 0.14 | 0.11 | 0.001 | Bal. | 80 | 0 | B: 22 V, 202 A | 10 | 120 | 61.0 | 0.4 |
| 20 | | | | | | | | | B: 30 V, 267 A | 9.3 | 119 | 60.5 | 0.5 |
| 21 | | | | | | | | | B: 38 V, 332 A | 14 | 116 | 60.5 | 0.2 |
| 22 | 0.35 | 0.27 | 0.18 | 0.1 | 0.003 | Bal. | 100 | 20 | C: 400° C., 100 m/min | 9.2 | 131 | 59.5 | 1.2 |
| 23 | | | | | | | | | C: 480° C., 100 m/min | 12 | 128 | 59.1 | 1.1 |
| 24 | | | | | | | | | C: 550° C., 100 m/min | 15 | 127 | 59.0 | 1.4 |
| 25 | 0.6 | 0.1 | 0.05 | 0.05 | 0.003 | Bal. | 20 | 0 | A: 320° C., 1 h | 8.4 | 103 | 62.3 | 0.3 |
| 26 | | | | | | | | | A: 380° C., 1 h | 11 | 106 | 62.5 | 0.2 |
| 27 | | | | | | | | | A: 450° C., 1 h | 14 | 109 | 62.1 | 0.3 |
| 28 | 0.7 | 0.14 | 0.04 | 0.04 | 0.002 | Bal. | 170 | 0 | A: 350° C., 2 h | 9.1 | 103 | 62.1 | 0.3 |
| 29 | | | | | | | | 20 | A: 410° C., 2 h | 9.5 | 106 | 62.0 | 0.4 |
| 30 | | | | | | | | 40 | A: 430° C., 2 h | 9.6 | 103 | 61.9 | 0.4 |

A: batch-type heat treatment,
B: electric current annealing,
C: CAL-type annealing

TABLE 2

| Comp. | | | | | | | Cooling | Red. | | | | | |
|---|---|---|---|---|---|---|---|---|---|---|---|---|---|
| ex | Fe | Cu | Mg | Si | Ti + V | Al | speed | ratio | Heat treatment | GS | TS | EC | Creep rate |
| No. | (mass %) | | | | | | (° C./sec) | (%) | Method | (μm) | (MPa) | (% IACS) | ×10⁻³ (%/hr) |
| 1 | 0.05 | 0.15 | 0.11 | 0.06 | 0.002 | Bal. | 130 | 0 | B: 28 V, 246 A | 20 | 78 | 62.5 | 0.3 |
| 2 | | | | | | | 30 | 0 | | 21 | 76 | 62.3 | 0.2 |
| 3 | | | | | | | 260 | 0 | | 20 | 78 | 62.4 | 0.3 |
| 4 | 0.28 | 0.11 | 0.15 | 0.1 | 0.02 | Bal. | 100 | 0 | B: 30 V, 252 A | 11 | 101 | 53.8 | 0.4 |
| 5 | | | | | | | | 20 | | 9.1 | 121 | 53.3 | 1.2 |
| 6 | | | | | | | | 40 | | 8.5 | 129 | 53.1 | 1.3 |
| 7 | | | | | | | 30 | 0 | B: 39 V, 340 A | 15 | 106 | 53.5 | 0.5 |
| 8 | | | | | | | 280 | | | 16 | 96 | 53.1 | 0.6 |
| 9 | 0.28 | 0.05 | 0.12 | 0.16 | 0.001 | Bal. | 50 | 20 | B: 32 V, 261 A | 11 | 98 | 60.1 | 6.3 |
| 10 | 0.23 | 0.37 | 0.15 | 0.18 | 0.001 | Bal. | 140 | 20 | | 13 | 129 | 53.7 | 1.3 |
| 11 | 0.28 | 0.12 | 0.001 | 0.12 | 0.002 | Bal. | 10 | 20 | | 11 | 76 | 61.1 | 6.2 |
| 12 | 0.25 | 0.17 | 0.3 | 0.17 | 0.002 | Bal. | 100 | 20 | | 12 | 107 | 54.1 | 1.3 |
| 13 | 0.29 | 0.12 | 0.13 | 0.008 | 0.001 | Bal. | 80 | 20 | | 11 | 77 | 60.8 | 3.8 |
| 14 | 0.28 | 0.11 | 0.15 | 0.3 | 0.002 | Bal. | 120 | 20 | | 11 | 82 | 53.7 | 1.3 |
| 15 | 0.64 | 0.001 | 0.002 | 0.01 | 0.001 | Bal. | 20 | 20 | | 8.3 | 71 | 62.8 | 6.5 |
| 16 | 0.23 | 0.12 | 0.15 | 0.07 | 0.002 | Bal. | 110 | 0 | A: 280° C., 1 h | Not | 142 | 58.5 | 3.4 |
| | | | | | | | | | | recrystallized | | | |
| 17 | | | | | | | | | A: 350° C., 0.05 h | Not | 144 | 59.1 | 4.3 |
| | | | | | | | | | | recrystallized | | | |
| 18 | | | | | | | | | B: 12 V, 110 A | Not | 178 | 58.8 | 4.8 |
| | | | | | | | | | | recrystallized | | | |
| 19 | | | | | | | | | B: 43 V, 386 A | 37 | 70 | 60.2 | 0.5 |
| 20 | | | | | | | | | C: 300° C., 80 m/min | Not | 188 | 59.4 | 3.8 |
| | | | | | | | | | | recrystallized | | | |
| 21 | | | | | | | | | C: 600° C., 100 m/min | 42 | 73 | 60.1 | 0.7 |

As is apparent from Tables 1 and 2, the tensile strength was low as 78 MPa or less in Comparative examples 1 to 3 in which the amount of Fe was too small. The electrical conductivity was low as 53.8% IACS or less in Comparative examples 4 to 8 in which the amount of Ti+V was too large. The creep rate was fast as 6.3×10⁻³ (%/hour) in Comparative example 9 in which the amount of Cu was too small; and the electrical conductivity was low as 53.7% IACS in Comparative example 10 in which the amount of Cu was too large. The tensile strength was low as 76 MPa and the creep rate was fast as 6.2×10⁻³ (%/hour) in Comparative example 11 in which the amount of Mg was too small; and the electrical conductivity was low as 54.1% IACS in Comparative example 12 in which the amount of Mg was too large. The tensile strength was low as 77 MPa and the creep rate was fast as 3.8×10⁻³ (%/hour) in Comparative example 13 in which the amount of Si was too small; and the electrical conductivity was low as 53.7% IACS in Comparative example 14 in which the amount of Si was too large. The tensile strength was low as 71 MPa and the creep rate was fast as 6.5×10⁻³ (%/hour) in Comparative example 15 in which the total amount of Cu, Mg, and Si was too small. The creep rate was fast as 3.4×10⁻³ (%/hour) or more in Comparative examples 16 to 18, and 20 in which the metal grain was not recrystallized; and the tensile strength was low as 73 MPa or less and the elongation was lower than those of other materials, and thus a defect on the crimped portion was concerned in Comparative examples 19 and 21 in which the grain size was too large.

Contrary to the above, in Examples 1 to 30, the creep rate was 1.4×10⁻³ (%/hour) or less, the tensile strength was 100 MPa or more, and the electrical conductivity was 55% or more, and thus, each of the properties were excellent. Furthermore, the elongation was also favorable.

### Examples 101 to 115, and Comparative examples 101 to 103

Next, other Examples and Comparative examples are shown. Aluminum alloy wire materials were obtained in the same manner as mentioned above, except that the alloy composition was changed to those described in Tables 3 and 4, respectively. In Comparative example 101, the final annealing heat treatment was not conducted, but cold working was conducted at a high reduction ratio as shown in Table 4. The properties were measured and evaluated in the same manner as mentioned above. Table 3 shows Examples according to the present invention, and Table 4 shows Comparative examples, respectively.

TABLE 3

| | | | | | | | Cooling | Red. | | | | | |
|---|---|---|---|---|---|---|---|---|---|---|---|---|---|
| Ex | Fe | Cu | Mg | Si | Ti + V | Al | speed | ratio | Heat treatment | GS | TS | EC | Creep rate |
| No. | (mass %) | | | | | | (° C./sec) | (%) | Method | (μm) | (MPa) | (% IACS) | ×10⁻³ (%/hr) |
| 101 | 0.11 | 0.10 | 0.17 | 0.08 | 0.002 | Bal. | 10 | 0 | B: 32 V, 280 A | 15 | 107 | 61.2 | 0.7 |
| 102 | 0.12 | 0.21 | 0.03 | 0.19 | 0.005 | Bal. | 40 | 0 | A: 450° C., 0.17 h | 21 | 114 | 59.9 | 0.2 |
| 103 | 0.19 | 0.12 | 0.07 | 0.09 | 0.004 | Bal. | 5 | 20 | B: 20 V, 180 A | 8.3 | 132 | 61.0 | 1.8 |
| 104 | 0.21 | 0.23 | 0.05 | 0.15 | 0.006 | Bal. | 1 | 30 | C: 410° C., 30 m/min | 7.3 | 150 | 59.2 | 0.9 |
| 105 | 0.22 | 0.25 | 0.18 | 0.06 | 0.009 | Bal. | 10 | 0 | A: 350° C., 2 h | 11 | 123 | 59.3 | 0.1 |
| 106 | 0.23 | 0.30 | 0.13 | 0.14 | 0.003 | Bal. | 20 | 40 | B: 25 V, 240 A | 7.5 | 166 | 58.4 | 0.3 |
| 107 | 0.29 | 0.11 | 0.14 | 0.16 | 0.003 | Bal. | 1 | 0 | A: 300° C., 2 h | 6.8 | 118 | 59.9 | 0.5 |
| 108 | 0.30 | 0.19 | 0.20 | 0.04 | 0.008 | Bal. | 20 | 0 | A: 400° C., 1 h | 10 | 123 | 59.7 | 0.2 |
| 109 | 0.32 | 0.24 | 0.09 | 0.03 | 0.006 | Bal. | 10 | 5 | C: 500° C., 100 m/min | 9.6 | 130 | 60.6 | 0.6 |
| 110 | 0.32 | 0.29 | 0.06 | 0.12 | 0.005 | Bal. | 0.5 | 10 | B: 38 V, 320 A | 10 | 142 | 59.4 | 0.9 |
| 111 | 0.38 | 0.12 | 0.04 | 0.10 | 0.002 | Bal. | 15 | 50 | C: 550° C., 150 m/min | 8.0 | 164 | 60.4 | 2.4 |
| 112 | 0.39 | 0.21 | 0.12 | 0.16 | 0.005 | Bal. | 5 | 0 | A: 400° C., 0.5 h | 8.2 | 130 | 59.0 | 0.6 |
| 113 | 0.60 | 0.14 | — | 0.06 | 0.006 | Bal. | 5 | 0 | A: 350° C., 2 h | 6.5 | 115 | 61.2 | 0.7 |
| 114 | 0.70 | — | 0.12 | 0.20 | 0.003 | Bal. | 10 | 5 | B: 26 V, 260 A | 6.0 | 124 | 59.3 | 0.7 |
| 115 | 0.80 | — | — | 0.11 | 0.002 | Bal. | 20 | 0 | A: 400° C., 1 h | 5.6 | 108 | 61.6 | 0.8 |

TABLE 4

| Comp. | | | | | | | | Cooling | Red. | | | | | |
|---|---|---|---|---|---|---|---|---|---|---|---|---|---|---|
| ex | Fe | Cu | Mg | Si | Ti + V | Zr | Al | speed | ratio | Heat treatment | GS | TS | EC | Creep rate |
| No. | (mass %) | | | | | | | (° C./sec) | (%) | Method | (μm) | (MPa) | (% IACS) | ×10⁻³ (%/hr) |
| 121 | 0.21 | 0.20 | 0.11 | 0.08 | 0.003 | — | Bal. | 20 | 99 | None | Not | 285 | 58.8 | 2.5 |
| | | | | | | | | | | | recrystallized | | | |
| 122 | 1.20 | — | 0.15 | 0.12 | 0.004 | — | Bal. | 15 | 0 | A: 350° C., 2 h | 2.8 | 121 | 59.0 | 1.8 |
| 123 | 0.22 | 0.15 | 0.10 | 0.15 | 0.004 | 0.21 | Bal. | 5 | 0 | A: 400° C., 1 h | Not | 156 | 52.7 | 0.02 |
| | | | | | | | | | | | recrystallized | | | |

As is apparent from Tables 3 and 4, the creep rate was fast as 2.5×10⁻³ (%/hour), and the tensile strength was too high and the elongation was too low, in Comparative example 101, in which no final annealing was conducted and the metal grain was not recrystallized, and thus a defect on the crimped portion was concerned as an industrial conductor. The creep rate was fast as 1.8×10⁻³ (%/hour), in Comparative example 102, in which no cold working was conducted after the final annealing and the amount of Fe was too large. In Comparative example 103 in which Zr was added, the metal grain was not recrystallized and the electrical conductivity was decreased conspicuously.

Contrary to the above, in Examples 101 to 115, the creep rate was 0.8×10⁻³ (%/hour) or less in the examples in which no cold working was conducted (cold reduction ratio was 0%) after the final annealing, and the creep rate was 2.4×10⁻³ (%/hour) or less in the examples in which cold working was conducted with the cold reduction ratio of 5 to 50% after the final annealing. Thus, each of the examples were excellent in creep resistance. Furthermore, the tensile strength was 100 MPa or more and the electrical conductivity was 55% or more, and thus, both of those properties were excellent, in both of the examples in which cold working was conducted after the final annealing and the examples in which no cold working was conducted after the final annealing. Moreover, the elongation was also favorable in each of the examples.

1. An aluminum alloy wire material, which has an alloy composition comprising: 0.1 to 0.4 mass % of Fe, 0.1 to 0.3 mass % of Cu, 0.02 to 0.2 mass % of Mg, and 0.02 to 0.2 mass % of Si, and further comprising 0.001 to 0.01 mass % of Ti and V in total, with the balance being Al and unavoidable impurities, wherein a grain size is 5 to 25 μm in a vertical cross-section in a wire-drawing direction thereof, and an average creep rate between 1 and 100 hours is 1×10⁻³ (%/hour) or less by a creep test under a 20% load of a 0.2% yield strength at temperature 150° C.

2. The aluminum alloy wire material according to claim 1, wherein a tensile strength is 80 MPa or more, and an electrical conductivity is 55% IACS or more.

3. The aluminum alloy wire material according to claim 1, which is mounted on a movable body as a wiring, and used as an electric conductor for a battery cable, a harness, or a motor.

4. An aluminum alloy wire material, which has an alloy composition comprising: 0.1 to 0.4 mass % of Fe, 0.1 to 0.3 mass % of Cu, 0.02 to 0.2 mass % of Mg, and 0.02 to 0.2 mass % of Si, and further comprising 0.001 to 0.01 mass % of Ti and V in total, with the balance being Al and unavoidable impurities, which is subjected to final annealing, followed by cold working at reduction ratio 5 to 50%, wherein a grain size is 5 to 25 μm in a vertical cross-section in a wire-drawing direction of the wire material, and an average creep rate between 1 and 100 hours is 5×10⁻³ (%/hour) or less by a creep test under a 20% load of a 0.2% yield strength at temperature 150° C.

5. The aluminum alloy wire material according to claim 4, wherein a tensile strength is 80 MPa or more, and an electrical conductivity is 55% IACS or more.

6. The aluminum alloy wire material according to claim 4, which is mounted on a movable body as a wiring, and used as an electric conductor for a battery cable, a harness, or a motor.

7. An aluminum alloy wire material, which has an alloy composition comprising: 0.3 to 0.8 mass % of Fe, and 0.02 to 0.5 mass % of at least one element selected from the group consisting of Cu, Mg, and Si in total, and further comprising 0.001 to 0.01 mass % of Ti and V in total, with the balance being Al and unavoidable impurities, wherein a grain size is 5 to 30 μm in a vertical cross-section in a wire-drawing direction thereof, and an average creep rate between 1 and 100 hours is 1×10⁻³ (%/hour) or less by a creep test under a 20% load of a 0.2% yield strength at temperature 150° C.

8. The aluminum alloy wire material according to claim 7, wherein a tensile strength is 80 MPa or more, and an electrical conductivity is 55% IACS or more.

9. The aluminum alloy wire material according to claim 7, which is mounted on a movable body as a wiring, and used as an electric conductor for a battery cable, a harness, or a motor.

10. An aluminum alloy wire material, which has an alloy composition comprising: 0.3 to 0.8 mass % of Fe, and 0.02 to 0.5 mass % of at least one element selected from the group consisting of Cu, Mg, and Si in total, and further comprising 0.001 to 0.01 mass % of Ti and V in total, with the balance being Al and unavoidable impurities, which is subjected to final annealing, followed by cold working at reduction ratio 5 to 50%, wherein a grain size is 5 to 30 μm in a vertical cross-section in a wire-drawing direction of the wire material, and an average creep rate between 1 and 100 hours is 5×10⁻³ (%/hour) or less by a creep test under a 20% load of a 0.2% yield strength at temperature 150° C.

11. The aluminum alloy wire material according to claim 10, wherein a tensile strength is 80 MPa or more, and an electrical conductivity is 55% IACS or more.

12. The aluminum alloy wire material according to claim 10, which is mounted on a movable body as a wiring, and used as an electric conductor for a battery cable, a harness, or a motor.
